(19) United States
(12) Patent Application Publication
(10) Pub. No.: US 2015/0084813 A1
(43) Pub. Date: Mar. 26, 2015

(54) GPS POSITIONING SYSTEM

(71) Applicant: PRECYSE TECHNOLOGIES, INC., Atlanta, GA (US)

(72) Inventor: Michael Braiman, Alpharetta, GA (US)

(21) Appl. No.: 14/391,733

(22) PCT Filed: Apr. 12, 2013
(86) PCT No.: PCT/US13/36327

§ 371 Date: Oct. 10, 2014

Related U.S. Application Data
(60) Provisional application No. 61/623,354, filed on Apr. 12, 2012.

(51) Int. Cl. G01S 19/13

(52) U.S. Cl. CPC G01S 19/13
USPC 342/357.51

(57) ABSTRACT

A system comprises a processing server programmed to determine which GPS satellites are currently available for use within a field of view of the processing server. The processing server is programmed to transmit to a terrestrial beacon information about a GPS channel of a GPS satellite which is not currently within the field of view of the processing server. The terrestrial beacon is configured to broadcast a navigation signal useful to determine location using the identified GPS channel. The processing server transmits the ephemeris of the terrestrial beacon to a GPS receiver. The receiver receives the signal from the beacon, and uses the ephemeris received from the processing server for calculating the receiver's location.

This application claims the benefit of U.S. Provisional Patent Application No. 61/623,354, filed Apr. 12, 2012, which is expressly incorporated by reference herein in its entirety.

### FIELD

This disclosure generally relates to an object tracking system and, more specifically, to a tracking system generating a GPS assisted data provided to an inquirable GPS smart tag attached to an object of interest.

### BACKGROUND

Global positioning systems (GPS) have become one of the most common tools used to determine an object's location accurately anywhere on the globe. Thus GPS has become a commonly used tool for navigation and for tracking fleets of vehicles, trucks, ships and airplanes. A GPS receiver calculates its position by measuring the distance between itself and three or more GPS satellites. The satellites are equipped with extremely accurate atomic clocks, and the receiver uses an internal crystal oscillator-based clock that is continually updated by using signals from the satellites. When distance to four satellites is measured simultaneously, the intersection of the four imaginary spheres determines the location of the receiver. Earth-based users can substitute the sphere of the planet for one satellite by using their altitude data. Typical measured position accuracy of GPS receivers is several meters. GPS receiver position measurement also has some limiting factors. The GPS receiver requires line-of-sight with at least four satellites.

U.S. Pat. No. 6,700,533, which is incorporated herein by reference, discloses a system for tracking objects outdoors. Tags attached to objects such as trailers include GPS receivers. Tags transmit uncorrected position and satellite data to a base station, where differential corrections are applied, providing 2-5 meter accuracy of the position of the tag and object. Tags are on a low duty cycle. When a tag powers on, it receives accurate time and current satellite data from the base station, enabling the tags to acquire the satellite signal quickly and with minimum power consumption. When a tag is out of base station range, the tag periodically calculates and archives its position. The tag may also include Real Time Locating Systems technology, to enable tracking to continue when the tag moves indoors and becomes inaccessible to GPS satellite signals.

The normally asleep tag is preprogrammed to periodically wake up and receive satellite position data from the base station and acquire the satellite signals. Pseudo-range data calculated at the tag from the acquired satellite signals are transmitted to the base station. The aforesaid tag wakes up independently whether it is within the coverage zone of the base station and characteristics of the tag displacement. Unassisted search of the satellite signal is an energy-consuming process and reduces tag battery life.

When the receiver is indoors or in an urban area, the signals received by a GPS receiver from the satellites are weak. Furthermore, some of the satellite data stream is broadcast at a very slow rate of 50 bits per second, thus taking several minutes for a conventional GPS receiver to download the required data from the satellites before computing its own location.

### SUMMARY

In some embodiments, a method, comprises receiving identification of a global positioning system (GPS) channel by at least one terrestrial beacon, where the GPS channel is not assigned to any GPS satellite which is currently within a field of view of a reference receiver; and transmitting signals from the at least one terrestrial beacon over the identified GPS channel.

In some embodiments, a method comprises identifying a global positioning system (GPS) channel which is not assigned to any GPS satellite currently within a field of view of a reference receiver; assigning the GPS channel to a terrestrial beacon, wherein the terrestrial beacon transmits ephemeris data using a format used by a GPS satellite to broadcast its ephemeris over the same GPS channel; and transmitting assisted GPS data to be received by a GPS receiver, the assisted GPS data including ephemeris of the terrestrial beacon.

In some embodiments, a system comprises a processing server programmed to determine which GPS satellites are currently within a field of view of the processing server, the processing server programmed to transmit information identifying at least one GPS satellite which is not currently within view; and at least one terrestrial beacon configured to receive the information identifying the at least one GPS satellite, and to broadcast signals over a GPS channel that is used by the at least one GPS satellite.

### BRIEF DESCRIPTION OF THE DRAWINGS

FIG. 1 is a schematic diagram of an AGPS tracking system according to an embodiment;

FIG. 2 is a block diagram of the smart tag shown in FIG. 1;

FIG. 3 is a block diagram of the ground base station shown in FIG. 1;

FIG. 4 is a block diagram of the beacon device shown in FIG. 1; and

FIG. 5 is a flow chart of a method for using the AGPS tracking system according to an embodiment.

FIG. 6 is a flow chart of a method using at least one terrestrial beacon.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

U.S. Pat. No. 7,855,679 B1, issued Dec. 21, 2010, is expressly incorporated by reference herein in its entirety.

In some embodiments, a method includes precisely tracking a plurality of GPS smart tags affixed to the movable objects of interest. The GPS smart tags are wirelessly linked to a service center via a plurality of ground stations covering a tracking area. Additionally, a plurality of beacon devices is disposed in the tracking area. The beacon devices are adapted to transmit their ID data via RF communication to the smart tags situated within the beacon service area. Each smart tag situated in the coverage zone of the base station is initialized under command of a service center. One method for determining the location of the smart tag comprises the following steps: (i) determining an approximate location of the smart tag by identifying the nearest beacon device or by triangulating the smart tag position using beacon signal measurements and (ii) determining a precise location of the smart tag by means of an Assisted GPS (AGPS) technology.

The system, which is known as Assisted GPS or AGPS, uses a wireless network to provide the GPS receiver with data, thereby assisting it to acquire the satellite's signal. In a preferred embodiment, the system provides Ephemeris data to the GPS receiver, which improves the time-to-first-fix (TTFF). The data provided to the GPS receiver can be either the Ephemeris data for visible satellites or, more helpfully the code phase and Doppler ranges over which the GPS device has to search, i.e. ‘acquisition assistance’. This technique improves the TTFF by many orders of magnitude, thus minimizing energy consumption. AGPS is also used to improve the sensitivity of the GPS device, thus improving the performance within buildings. By providing so called ‘sensitivity assistance’ (based roughly on the estimated position of the GPS receiver) to the GPS device, it is able to better correlate the signal being received from the satellite when the signal is low in strength.

Being provided with assisted data, the smart tag receives satellite-broadcasted signals and calculates pseudo-ranges from the tag to the satellites. After transferring data, the smart tag is restored to a cold standby condition. The calculated pseudo-range data is transferred to the service center adapted to determine a smart tag location.

The term ‘Assisted GPS’ (AGPS) relates to a configuration consisting of a GPS server and plurality of simple mobile GPS receivers connected via a communication link. The mobile GPS receivers are assisted by the GPS server providing data and processing power for position measurement.

The term ‘GPS smart tag’ relates to tags consisting of a GPS receiver, a processor, such as an embedded CPU providing processing power and an interface to a dedicated wireless communication link.

The term ‘Almanac’ relates to coarse time information and status information about the satellites included in the primary navigation signal broadcasted by a satellite.

The term ‘Ephemeris’ relates to information that allows the receiver to calculate the position of the satellite.

The term ‘Assisted data’ relates to data generated by the service center and provided to the GPS smart tag for shortening Time To First Fix (“Acquisition Assistance”) and increasing sensitivity (“Sensitivity Assistance”). This data comprises at least one element selected from the group consisting of almanac, ephemeris, code phase, and Doppler ranges characterizing the satellite-broadcasted signal.

The term ‘Pseudo-range’ relates to the range of each of the satellites used by a GPS receiver and is calculated by the time delay of signals received from each satellite. The pseudo-range values are further used to calculate the GPS receiver position by triangulation.

The term ‘pseudo random’ relates to numbers that are generated digitally and approximate the properties of random numbers.

The term ‘Radio frequency (RF) beacon’ relates to a radio transmitter transmitting identification data within an area of the transmitter antenna.

The term ‘Central processing server’ relates to a central processing platform recording location data obtained from all the system smart tags in the database.

The term ‘Application server’ relates to a user interface platform.

The term ‘Application interface’ (API) relates to user interface software running on the central processing server and the application server.

The term ‘System console’ relates to a terminal usable for operating the system.

The term ‘IP’ is the acronym of internet protocol.

The term ‘MCU’ is an acronym for a microcontroller unit.

The term ‘Receive Signal Strength Indicator’ refers to a circuit to measure the strength of an incoming signal. The basic circuit is designed to pick an RF signal and to generate an output equivalent to the signal strength.

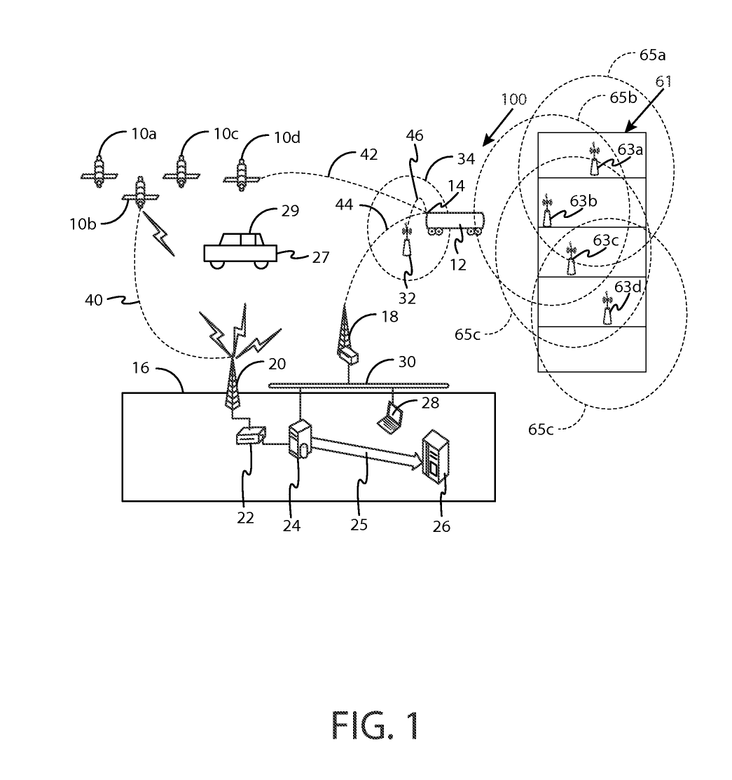

Reference is now made to FIG. 1, schematically illustrating a block diagram of an AGPS smart tag system 100 according to an exemplary embodiment . As seen in FIG. 1, the system 100 comprises a service center 16, a ground base station 18, a beacon 32, and a smart tag 14 adapted to releasably affix to an object of interest 12, such as a truck, or a car 27 equipped with a GPS receiver 29. The ground base station 18 is connected to the service center 16 via IP network 30. The service center 16 further comprises a central processing server 24, a customer application server 26 connected to the central processing server 24 via an application programming interface 25, and stationary GPS receiver 22 furnished with an antenna 20. The receiver 22 and the smart tag 14 are adapted for to receive signals broadcasted by satellites 10a . . . 10d via wireless communication channels 40 and 42, respectively. The ground base station 18 is adapted to wirelessly RF-communicate with the smart tag 14 via a channel 44. The stationary GPS receiver 22 furnished with the antenna 20 is adapted to search for and receive signals broadcasted by the satellites available for receiving. As seen in FIG. 1, the beacon device 32 has a service zone 34.

In some embodiments, the smart tag 14 affixed to an object of interest 12 is situated in the service zone 34 of the beacon device 32. The smart tag 14 is woken up by either itself when sensing predefined events (such as motion or time elapsed) or a command sent from the service center 16. Being woken up, for example, by the service center 16, the smart tag 14 receives a signal from the beacon device 32 via wireless communication channel 46. The aforesaid signal carries ID data of this specific beacon 32. The smart tag 14 measures parameters of the beacon signal and derives the beacon ID data. Further the beacon 32 retransmits the received beacon ID and signal measurement data to the service center 16. The beacon ID data enables the service center 16 to determine an approximate location of the smart tag 14 and provide the smart tag 14 with assisted data. This data is generated according to satellite-broadcasted signals receivable by the stationary reference GPS receiver 22.

As said above, providing the smart tag 14 with assisted data enables the system 100 to reduce energy consumption due to shortening TTFF (acquisition assistance) and more reliable reception (sensitivity assistance) that is very important in indoor conditions.

The smart tag 14 performs signal search according to the received assisted data, receives satellite-broadcasted signals and calculates pseudo-ranges from the tag 14 to the available satellites 10a, 10b, 10c, and 10d. The calculated pseudo-ranges are transmitted to the service center 16 for further processing. The central processing server 24 is adapted to calculate a location of the smart tag 14 by means of triangulating the obtained pseudo-ranges.

Reduced power consumption comes about because the smart tag 14 is in standby condition and is woken up for a short time on demand.

The assisted data may be used to help the smart tag 14 or GPS receiver 29 to acquire satellites 10a-10d. The satellites' information is pushed to the smart tag 14 or GPS receiver 29 over the network channel 44. Once the assisted data (ephemeris information) is pushed to the smart tag 14 or GPS receiver 29, when the smart tag 14 or receiver 29 starts, it need not search for all the satellites 10a-10d. It knows exactly which satellites 10a-10d are in view at any given time. There is no need to search for all of the satellites all of the time.

As noted above, the GPS system satellites 10a-10d are not always visible. If the smart tag 14 or GPS receiver 29 is indoors and/or if the tag or receiver is located in an urban area with many tall buildings, the RF signals from the GPS satellites 10a-10d may not reach the tag or receiver.

In some embodiments, to supplement the GPS satellites as sources of the assisted data, a plurality of terrestrial beacons 63a-63d are provided at known locations. For example, in FIG. 1, a building 61 has a plurality of indoor beacons 63a-63d at various locations and/or altitudes. Each beacon 63a-63d has a respective service zone 65a-65d. In any given system, any number of terrestrial beacons may be provided to supplement the constellation of GPS satellites available at any given time. For example, a large building may have five, six, ten or more of such beacons 63a-63d. Depending on the type of beacon, the service zone 65a-65d for each beacon 63a-63d may extend anywhere from three to 2400 feet (1 to 720 meters).

In some embodiments, the system substitutes a plurality of underground, close-to-the-ground or ground terrain based beacons 63a-63d (collectively referred to herein as terrestrial beacons) for the currently unused satellite channels. These terrestrial beacons 63a-63d transmit signals in the same format as the missing or unused satellites' signal, using the same CDMA code as the satellite for which the beacon's broadcast is substituted. Each beacon transmits a satellite ID No. which is assigned to it by the central processing server 24, and transmits its own “ephemeris”, all using the same format used by GPS satellites 10a-10d to transmit their ephemeris.

The full message transmitted by each beacon includes: a basic format of a 1500-bit-long frame made up of five subframes, each subframe being 300 bits long. Subframes 4 and 5 are subcommutated 25 times each, so that a complete message includes 25 full frames. Each subframe has ten words, each 30 bits long. Thus, with 300 bits in a subframe times 5 subframes in a frame times 25 frames in a message, each message is 37,500 bits long. Subframe 1 includes the clock time; subframes 2-3 include the ephemeris; and subframes 4-5 include the almanac, a summary of the satellite network, including coarse orbit and status information for up to 32 satellites in the constellation. Signals are encoded using code division multiple access (CDMA) with the same unique encodings designated for each satellite. The encodings may be the coarse/acquisition (C/A) code, which is accessible by the general public. Military applications may use an encrypted precise (P) code.

In addition, the assisted data (ephemeris data) from out-of-view satellites from the most-recently-received almanac is replaced with data identifying the ephemeris of the corresponding terrestrial beacons 63a-63d, transmitted using the same CDMA code. In the formation of the assisted data, the ephemeris data associated with the terrestrial beacons 63a-63d are included, corresponding to “virtual satellites” having respective ephemeris corresponding to the locations of the beacons. The assisted data is transmitted to the smart tag 14 and GPS receiver 29, so they will look for GPS satellites at the locations of terrestrial beacons 63a-63d, and will find them (i.e., receive their signals on the expected GPS channels). Thus, the receiver 29 and smart tag 14 do not require special hardware or software. The assisted data and satellite ID No. are in the same format as, and processed by the same processor in receiver 29 and smart tag 14 used to calculate location based on signals from real orbiting satellites.

The location of the beacon is now known to the smart tag 14 or GPS receiver 29 because the data of this tag or receiver is replaced with the new coordinates and pushed from the central processing server 24 (connected to the reference GPS receiver 22) to the smart tag 14 or GPS receiver 29. Now the smart tag 14 or GPS receiver 29 receives signals transmitted by the beacon 63a-63d, including the data indicating where a “satellite” having the same ephemeris as the terrestrial beacon transmitting the signal is currently located. Because the beacon location data has the same format as the data the smart tag 14 or GPS receiver 29 receives from any real GPS satellite, the tag 14 or receiver 29 can use the beacon's data to calculate a location (in place of one of the four GPS satellites, from which the signals would normally be used. Depending on the number of actual satellites' signals received at any given time, the smart tag 14 or GPS receiver 29 may use anywhere from one to four beacons in place of respective satellites at any given time.

At any given time, several GPS receiver channels are available. In some embodiments, the terrestrial beacons 63a-63d use the channels that are allocated to the satellites 10a-10d currently below the horizon (e.g., on the other side of the world), Channels currently used by GPS satellites 10a-10d above the horizon (with respect to the GPS receiver 22) are not used for the beacons 63a-63d.

The central processing server 24 (the “reference receiver”) constantly searches the sky for available GP S signals from satellites within its field of view, and thus always knows which satellites are currently in view at any given time, and which are not. So the central processing server 24 determines that at a given time, given the subset of GPS satellites 10a-10d currently in view, which other channels are available. The central processing server 24 generates the ephemeris and broadcasts it to the beacons 63a-63d by way of the base station 18. The beacons 63a-63d will each receive its own temporary satellite number (and CDMA code) and will start transmitting exactly the pattern and the encoding of this specific satellite which is currently not visible in this area.

In other embodiments, currently unused channels are used for the beacons 63a-63d. For example, a GPS receiver may be configured and programmed to look for up to 100 satellites 10a-10d, but the current satellite constellation only includes 32 satellites 10a-10d in orbit. The approximately 68 remaining channels and satellite IDs (encodings) are reserved for satellites not currently in orbit. In some embodiments, some or all of those channels and IDs are used by the terrestrial beacons 63a-63d. Because these channels are not currently being used by any GPS satellite 10a-10d, there is no need to determine whether the satellite using that channel is currently above the horizon. Further, there is no need to change the satellite encoding assigned to each beacon 63a-63d as the subset of visible satellites changes throughout the day.

From the perspective of the smart tag 14 or GPS receiver 29, every time the tag or receiver needs to acquire the position, the tag or receiver wakes itself, or the central processing server 24 (coupled to reference GPS receiver 22) wakes up the smart tag 14 or GPS receiver 29, and pushes the assisted data into it. The central processing server 24 receives the satellite data via receiver 22, calculates a position and sends it back to the smart tag 14 or GPS receiver 29. And the tag sends it back to the base station 18. The smart tag 14 or GPS receiver 29 receives not only the position of the satellites 10a-10d, currently in view, but also the position of the beacons 63a-63d mimicking other satellites. The smart tag 14 or GPS receiver 29 can use the same location determining algorithm, the same way as when four satellites 10a-10d are within view, with no additional hardware and software to actually acquire now a position indoors.

In some embodiments, the smart tags 14 and/or GPS receivers 29 have a separate communication channel for receiving the assisted data. For example, the GPS receiver 29 may be embedded in a smart phone, which receives the assisted data over a cellular telephone network. As another example, the GPS receiver may be a standalone device or a vehicle installed device, with a separate channel for the assisted data.

The system can be used in two modes. The first is with assisted GPS data, as described above, in which the ephemeris data is pushed from the central server through the network to each of the receivers, to permit rapid “first fix” of the location by the smart tag 14 or GPS receiver 29.

The second mode is standalone or autonomous operation, in which the GPS receiver 29 determines its location using signals from 0-4 satellites plus 4-0 beacons 63a-63d, without the assisted data, and the GPS receiver actually searches the sky for all available satellites. Because each of the beacons 63a-63d transmits its own ephemeris, a standalone GPS receiver 29 (without the assisted data) is still able to use the ephemeris information transmitted by the beacons 63a-63d to calculate its location. When four satellites are not available, the GPS receiver 29 determines its location using signals from 0-3 satellites plus 4-1 beacons 63a-63d.

In the case of standalone operation, although the GPS receiver 29 will use up to 12.5 minutes to receive a full GPS message, the beacons 63a-63d provide a stronger, more reliable signal than the real GPS satellites, in certain conditions. For example, in a city, the satellite signals may suffer multipath propagation if signals bounce off buildings, or be weakened by passing through atmospheric conditions, walls or tree cover.

Thus, standalone operation using the beacons 63a-63d is advantageous, even for GPS receivers that are not configured to use AGPS. Thus, the additional indoor beacons 63a-63D may be used in any GPS or AGPS system.

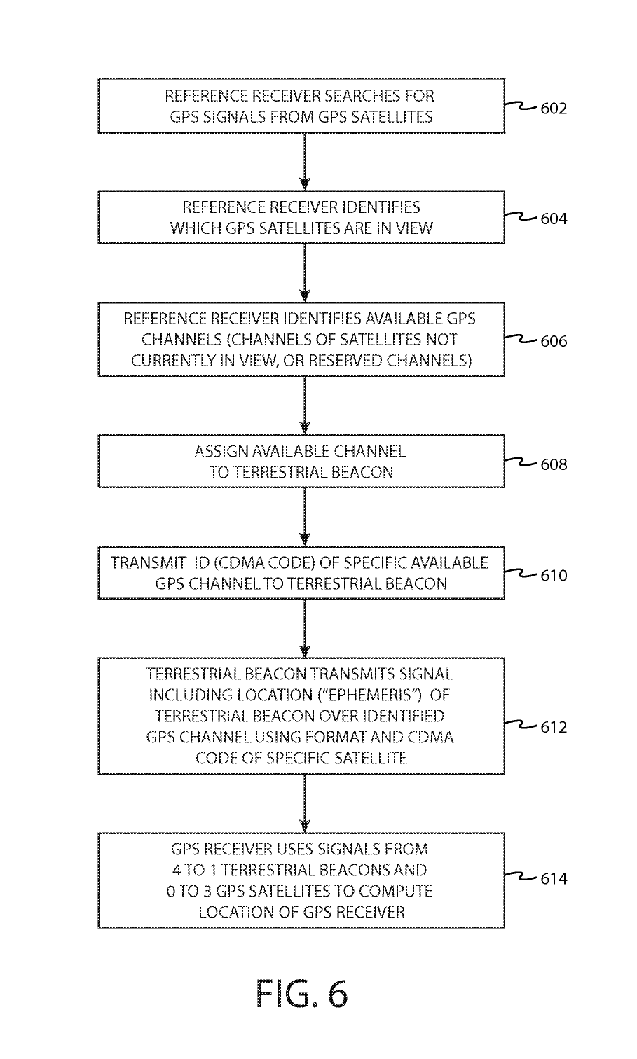

FIG. 6 is a flow chart summarizing the above operations.

At step 602, the reference receiver 24 searches for GPS signals from GPS satellites.

At step 604, the reference receiver 24 identifies which GPS satellites are in view.

At step 606, the reference receiver identifies available GPS channels (i.e., channels of satellites not currently within the field of view of the reference receiver 24, or reserved channels.

At step 608, the reference receiver assigns a specific available channel to a terrestrial beacon 63a-63d.

At step 610, the reference receiver transmits an identification (a CDMA code) of the specific available GPS channel to the terrestrial beacon.

At step 612, the terrestrial beacon transmits signals including the location (“ephemeris”) of the terrestrial beacon over the identified GPS channel using the format and CDMA code of the specific satellite.

At step 614, the receiver uses signals from 4 to 1 terrestrial beacons and 0 to 3GPS satellites to compute the location of the smart tag or GPS receiver.

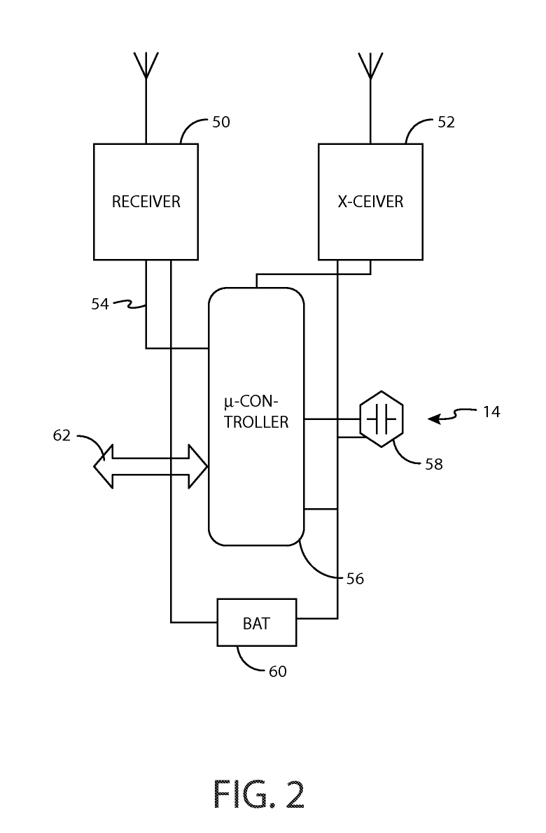

Reference is now is made to FIG. 2, presenting a block diagram of the AGPS smart tag 14. The aforesaid smart tag comprises an AGPS receiver 50, an RF-transceiver 52, a data bus 54, a microcontroller unit 56, a motion sensor 58, a battery 60, and I/O port 62.

As said above, the AGPS smart tag 14 is in standby condition by default. The tag is woken up by either itself when sensing predefined events (such as motion or time elapsed) or a command sent from the service center 16 via the wireless RF-communication channel 44. The transceiver 52 receives a signal from the beacon device 32 via wireless communication channel 46. The aforesaid signal carries ID data of the specific beacon 32. The microcontroller 56 measures signal parameters and derives the beacon ID data. Optionally, a received signal strength indicator and a phase delay or any combination thereof are measured by microcontroller 56.

Further, the transceiver 52 retransmits the received beacon ID and signal measurement data to the service center 16. The beacon ID data enables the service center 16 (not shown) to determine an approximate location of the smart tag 14, generate the assisted data, and provide the smart tag 14 with the approximate location and the assisted data.

Being provided with assisted data, the AGPS receiver 50 searches and receives the satellite-broadcasted signals. The pseudo-random waveform received by GPS receiver 50 is compared with an internally generated version of the same code with delay control, until both waveforms are synchronized. The obtained delay of internal pseudo-random form corresponding to the waveform synchronization defines the travel time of the GPS signal from the satellite to the receiver 50. The obtained delay values are provided via the data bus 54 to the microcontroller unit 56. The delay values (pseudo-ranges) further are transferred to the service center 16 via an RF-communication link 44 for calculating the smart tag location. Thereafter, the smart tag 14 restores to the standby condition.

The smart tag 14 is a mobile battery-powered device. Therefore, the suggested mode of short-time sessions of pseudo-range measurements secures a long battery service life. The smart tag 14 further comprises a motion sensor 58 enabling the service center to assist tracking the smart tag 14 outside the service area. I/O port 62 provides a connection of peripheral devices (not shown) to the smart tag 14 and two-way data interchange between the aforesaid device and the service center 16.

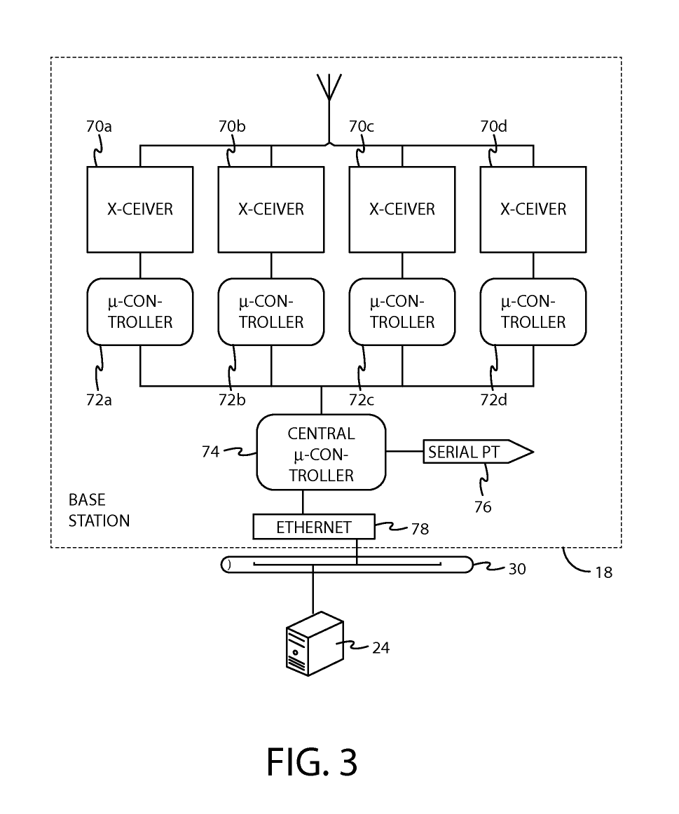

Reference is now made to FIG. 3, schematically illustrating a block diagram of the architecture of the ground base station 18. The aforesaid base station 18 is a ground communication unit communicating with the plurality of mobile smart tags via wireless communication links.

The base station 18 comprises four independent RF transceiver modules 70a, 70b, 70e, and 70d (rack transceiver) operating simultaneously. The rack transceiver is required for supporting the frequency diversity mode of operation, providing the required capabilities for withstanding external interferences. Microcontroller units 72a, 72b, 72c, and 72d perform management of the data stream in transceivers 70a, 70b, 70e, and 70d, respectively.

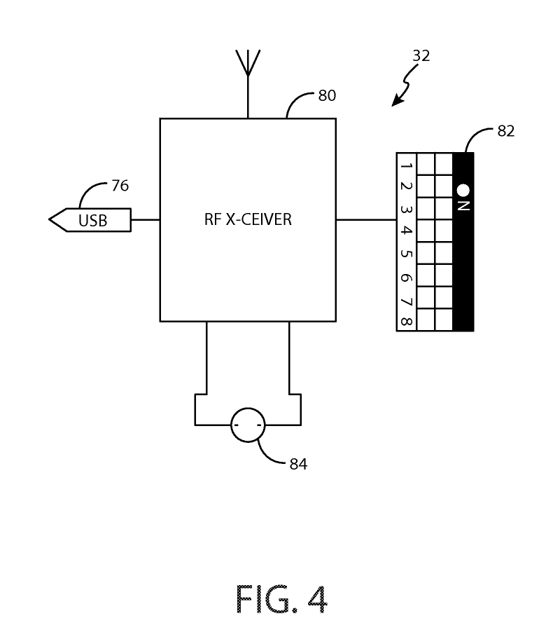

A central microcontroller unit 74 is responsible for activating and controlling internal operational logic of the base station 18. A serial port 76 connects peripheral devices to the base station 18. As seen in FIG. 4, the base station 18 further comprises Ethernet chipset 78 for connecting to the Ethernet 30. The base station 18 is controlled by central processing server 24 via the Ethernet connection 30.

Reference is now made to FIG. 4, presenting a block diagram of the AC/DC (84)-powered beacon device 32 comprising an RF-transceiver 80 capable of transmitting beacon device ID data at the predetermined frequency and time. The beacon device 32 is furnished with an attenuator 82 and the serial or USB port 76 enabling the service center to change over the air a level of emitted power and configuring and maintaining the beacon device 32, respectively.

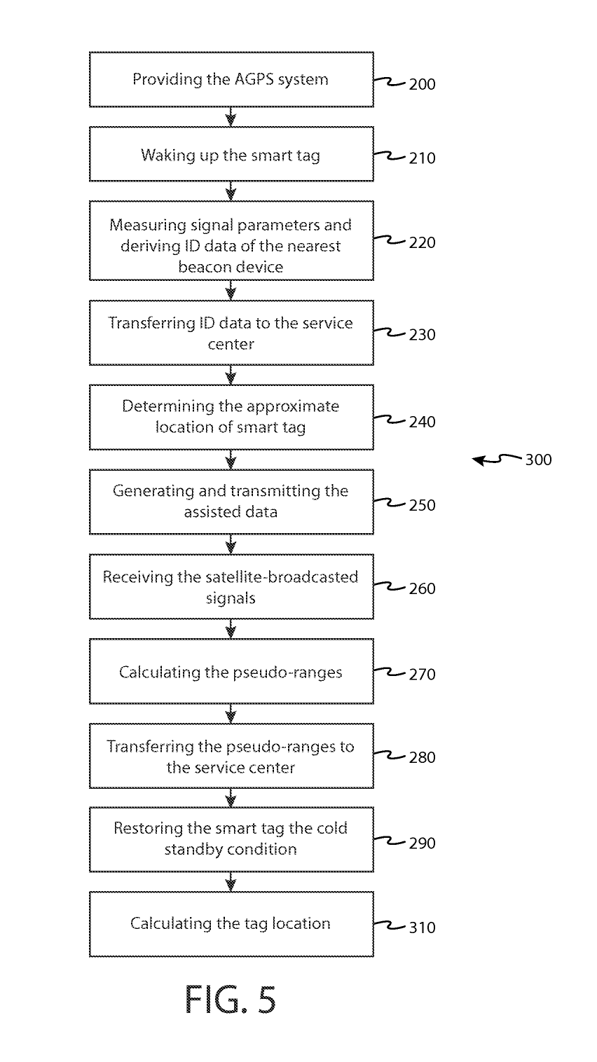

Reference is now made to FIG. 5, showing a flowchart of a method 300 for using an AGPS system for tracking an object of interest, according to some embodiments. In step 200, an AGPS system is provided having a smart tag. The smart tag is woken up at step 210. The smart tag measures RF-signals of the nearest beacon devices in-view and derives signal ID data of the nearest beacon device at step 220. The smart tag then retransmits signal measurement and ID data to the service center (step 230). The service center determines an approximate location of the smart tag (step 240) and generates and transmits the assisted data (step 250), which may include the ephemeris of the terrestrial beacons 63a-63d, as well as the satellites 10a-10d. As stated above, the assisted data provides both acquisition and sensitivity assistance. Stated another way, using the assisted data shortens TTFF and increases reliability of the objects location in indoor conditions.

The smart tag receives the satellite-broadcasted signals and the signals from the terrestrial beacons 63a-63d at the further step 260 according the assisted data.

Calculating the pseudo-ranges at step 270 is based on the obtained satellite signals. The calculated pseudo-ranges are transferred to the service center at the step 280. Restoring the smart tag to the cold standby condition at the step 290 secures reduced power consumption and enhances battery life. Calculating the tag location at the step 310 ends the flowchart 300. The obtained result provides coordinates characterizing the smart tag location.

Thus, in some embodiments, the reduction of power consumption is attained due to initializing the smart tag by the service center during determining the smart tag location and restoring the aforesaid tag to the cold standby condition after transmitting the pseudo-ranges.

The preliminary determination of the approximate tag location using the beacon devices enables the service center to provide improved GPS assistance by means of transmitting more precise satellite data to the smart tag.

Although the subject matter has been described in terms of exemplary embodiments, it is not limited thereto. Rather, the appended claims should be construed broadly, to include other variants and embodiments, which may be made by those skilled in the art.

1. A method, comprising:
receiving identification of a global positioning system (GPS) channel by at least one terrestrial beacon, where the GPS channel is not assigned to any GPS satellite which is currently within a field of view of a reference receiver; and
transmitting signals from the at least one terrestrial beacon over the identified GPS channel.

2. The method of claim 1, wherein the transmitting step is performed using a format used by a specific GPS satellite which uses the identified GPS channel to broadcast its ephemeris.

3. The method of claim 2, wherein the signals are transmitted from the at least one terrestrial beacon using a CDMA code which is same as a CDMA code used by the specific GPS satellite.

4. The method of claim 1, further comprising:
using the reference receiver to search for GPS signals from one or more GPS satellites,
identifying from which GPS satellites the GPS signals are received by the reference receiver; and
determining that the specific GPS satellite is not within a field of view of the reference receiver based on whether any GPS signals are received from the specific GPS satellite.

5. The method of claim 1, further comprising:
determining one or more reserved GPS channels which is not currently assigned to any GPS satellite;
wherein the identified GPS channel is from among the one or more reserved GPS channels.

6. The method of claim 1, wherein the signals transmitted from the at least one terrestrial beacon contain ephemeris data of the at least one terrestrial beacon.

7. The method of claim 6, further comprising encoding the position data according to an encoding used by the specific GPS satellite.

8. The method of claim 1, wherein a GPS receiver uses the signals transmitted from the at least one terrestrial beacon in place of signals from at least one corresponding GPS satellite, for computing a location of the GPS receiver.

9. A method, comprising:
identifying a global positioning system (GPS) channel which is not assigned to any GPS satellite currently within a field of view of a reference receiver;
assigning the GPS channel to a terrestrial beacon, wherein the terrestrial beacon transmits ephemeris data using a format used by a GPS satellite to broadcast its ephemeris over the same GPS channel; and
transmitting assisted GPS data to be received by a GPS receiver, the assisted GPS data including ephemeris of the terrestrial beacon.

10. The method of claim 10, further comprising, before the transmitting step, substituting the ephemeris of the terrestrial beacon into the assisted GPS data in place of ephemeris of a GPS satellite which is assigned to the GPS channel.

11. The method of claim 9, wherein the information transmitted to the terrestrial beacon includes a CDMA code used by the GPS satellite for transmitting its ephemeris over the same GPS channel.

12. The method of claim 9, further comprising:
using the reference receiver to search for GPS signals from one or more GPS satellites,
identifying from which GPS satellites the GPS signals are received; and
determining that a specific GPS satellite is not currently within a field of view of the reference receiver based on absence of any GPS signals received from the specific GPS satellite.

13. The method of claim 9, further comprising:
determining one or more reserved GPS channel which is not currently assigned to any GPS satellite, wherein the identified channel is from among the one or more reserved GPS channel.

14. A system comprising:
a processing server programmed to determine which GPS satellites are currently within a field of view of the processing server, the processing server programmed to transmit information identifying at least one GPS satellite which is not currently within view; and
at least one terrestrial beacon configured to receive the information identifying the at least one GPS satellite, and to broadcast signals over a GPS channel that is used by the at least one GPS satellite.

15. The system of claim 14, wherein the processing server is programmed to
search for GPS signals from one or more GPS satellites within a field of view of the processing server, and determines which channels are available based on which satellites are within the field of view,

16. The system of claim 14, wherein the processing server is programmed to determine one or more reserved GPS channel which is not currently assigned to any GPS satellite, wherein the determined channel is from among the one or more reserved GPS channel.

17. The system of claim 14, wherein the processing server transmits a CDMA code of a specific GPS satellite to the terrestrial beacon, and the terrestrial beacon is configured to transmit signals containing ephemeris data over the at least one available GPS channel using the CDMA code.

18. The system of claim 17, wherein the terrestrial beacon is programmed to transmit the signals using a same format used by the specific GPS satellite for broadcasting ephemeris data.

19. The system of claim 18, wherein the terrestrial beacon is programmed to transmit a message containing an almanac in which GPS data from at least one out-of-view satellite is replaced with data identifying the ephemeris of the terrestrial beacon.

20. The system of claim 14, wherein the system includes a plurality of terrestrial beacons at a plurality of locations and/or altitudes.

21. The system of claim 20, wherein two or more of the plurality of terrestrial beacons are included inside a building.
